(19) United States
(12) Patent Application Publication
(10) Pub. No.: US 2024/0378364 A1
(43) Pub. Date: Nov. 14, 2024

(54) METHOD AND APPARATUS FOR ROUTING SIGNAL LINE, AND DEVICE AND READABLE STORAGE MEDIUM

(71) Applicant: SUZHOU METABRAIN INTELLIGENT TECHNOLOGY CO., LTD., Suzhou, Jiangsu (CN)

(72) Inventor: Xuchen SHAO, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/692,773

(22) PCT Filed: Jun. 28, 2022
(86) PCT No.: PCT/CN2022/101947

§ 371 Date: Mar. 15, 2024

(30) Foreign Application Priority Data
Nov. 19, 2021 (CN) 202111392011.5

(51) Int. Cl. G06F 30/3953; G06F 30/3947; G06F 115/12; G06F 117/12

(52) U.S. Cl. CPC G06F 30/3953; G06F 30/3947; G06F 2115/12; G06F 2117/12

(57) ABSTRACT

The present disclosure relates to the technical field of Printed Circuit Board (PCB) routing. Disclosed are a method and apparatus for routing signal line, and a device and a readable storage medium. The method includes: acquiring a signal line of a PCB and an original segmentation region corresponding to a reference plane; determining whether the signal line crosses the original segmentation region; when the signal line crosses the original segmentation region, expanding the original segmentation region to obtain a target segmentation region; and routing the signal line to the target segmentation region.

### CROSS-REFERENCE TO RELATED APPLICATION

The present application is a National Stage Application of PCT International Application No.: PCT/CN2022/101947 filed on Jun. 28, 2022, which claims priority to Chinese Patent Application 202111392011.5, filed in the China National Intellectual Property Administration on Nov. 19, 2021, the disclosure of which is incorporated herein by reference in its entirety.

### TECHNICAL FIELD

The present disclosure relates to the technical field of Printed Circuit Board (PCB) routing, and specifically to a method and apparatus for routing signal line, and a device and a readable storage medium.

### BACKGROUND

With the acceleration of signal rates, the demand for high-speed signals is increasing, and Printed Circuit Boards (PCBs) develop accordingly in a direction of high speed and high density. However, the high-speed signals are high in routing integration and large in routing density, such that multi-layer boards are generally used to reduce signal interference. The high-speed signal uses a reference plane as a return path. When the reference plane is incomplete, impedance discontinuity of the signal is caused, and reflections are generated in the signal, such that PCB routing needs to be as close to a plane as possible, and the plane needs to be ensured to be as complete as possible.

However, during actual PCB routing, an incomplete reference plane is caused due to the segmentation of a power plane or the segmentation of a ground plane, resulting in a problem of segmentation crossing arrangement of a signal line. For the problem, the number of PCB layers is generally increased to make each pair of high-speed signals have complete reference planes, or the high-speed signal is enabled to pass through networks of two planes segmented by the reference plane by means of increasing stitching capacitors. However, the cost of PCBs is undoubtedly increased due to the increase in the number of PCB layers, and due to structural limitations, the number of PCB layers cannot be increased indefinitely, and there may be no space to place the stitching capacitors due to space limitations. Therefore, the problem of segmentation crossing arrangement of the signal line in the case of limited space and limited number of PCB layers needs to be solved urgently.

### SUMMARY

According to a first aspect, an embodiment of the present disclosure provides a method for routing signal line. The method includes: a signal line of a Printed Circuit Board (PCB) and an original segmentation region corresponding to a reference plane are acquired; it is determined whether the signal line crosses the original segmentation region; in response to the signal line crossing the original segmentation region, the original segmentation region is expanded to obtain a target segmentation region; and the signal line is routed to the target segmentation region.

In combination with the first aspect, in some embodiments of the first aspect, in response to the signal line not crossing the original segmentation region, set positions of other signal lines are identified; or in response to the signal line not crossing the original segmentation region, analog simulation is performed on the signal line to determine impedance of the signal line.

In combination with the first aspect, in a first implementation of the first aspect, the segmentation region is expanded to obtain the target segmentation region includes: a first reference plane and a second reference plane corresponding to the original segmentation region are acquired, and a network attribute of the first reference plane is consistent with a network attribute of the original segmentation region; and the first reference plane is reduced to obtain the target segmentation region, and a width of the target segmentation region is greater than a width of the original segmentation region.

In combination with the first implementation of the first aspect, in a second implementation of the first aspect, the signal line is routed to the target segmentation region includes: a thickening value of the signal line is calculated; a thickening operation is performed on the signal line based on the thickening value, so as to obtain a thickened signal line; and the thickened signal line is routed to the target segmentation region.

In combination with the first implementation of the first aspect, in a third implementation of the first aspect, the method further includes: a signal via is provided within a preset range from the signal line, and a network attribute of the signal via is consistent with the network attribute of the first reference plane.

In combination with the third implementation of the first aspect, in a fourth implementation of the first aspect, the method further includes: a third reference plane is provided under the target segmentation region, and a network attribute of the third reference plane is consistent with the network attribute of the first reference plane.

In combination with the first aspect, in a fifth implementation of the first aspect, the original segmentation region of the reference plane in the PCB is acquired includes: the reference plane corresponding to the signal line in the PCB is acquired; it is determined whether the reference plane corresponding to the signal line is complete; and in response to the reference plane corresponding to the signal line being incomplete, the original segmentation region of the reference plane in the PCB is acquired.

In combination with the first aspect, in some embodiments of the first aspect, the method further includes in response to the reference plane corresponding to the signal line being complete, analog simulation is performed on the signal line to determine signal characteristics of the signal line.

In combination with the first aspect, in a sixth implementation of the first aspect, it is determined whether the signal line crosses the original segmentation region includes: a first width corresponding to the signal line and a second width corresponding to the original segmentation region are acquired; it is determined whether the first width is greater than the second width; and in response to the first width is greater than the second width, it is determined that the signal line crosses the original segmentation region.

In combination with the first aspect, in some embodiments of the first aspect, the method further includes: in response to the first width being less than or equal to the second width, it is determined that the signal line does not cross the original segmentation region.

According to a second aspect, an embodiment of the present disclosure provides an apparatus for routing signal line. The apparatus includes: an acquisition component, configured to acquire a signal line of a PCB and an original segmentation region corresponding to a reference plane; a determination component, configured to determine whether the signal line crosses the original segmentation region; an expansion component, configured to in response to the signal line crosses the original segmentation region, expand the original segmentation region to obtain a target segmentation region; and a routing component, configured to route the signal line to the target segmentation region.

According to a third aspect, an embodiment of the present disclosure provides an electronic device, which includes a memory, and one or more processors. The memory stores a computer-readable instruction, and when the computer-readable instruction is executed by the one or more processors, the one or more processors are enabled to execute the method for routing signal line described in any one of the implementations.

According to a fourth aspect, an embodiment of the present disclosure provides one or more non-volatile computer-readable storage medium, storing a computer-readable instruction. When the computer-readable instruction is executed by one or more processors, the one or more processors are enabled to execute the method for routing signal line described in any one of the implementations.

### BRIEF DESCRIPTION OF THE DRAWINGS

In order to more clearly illustrate the specific implementations of the present disclosure or the technical solutions in the related art, the drawings used in the description of the specific implementations or the related art will be briefly described below. It is apparent that the drawings in the following descriptions are some implementations of the present disclosure. Other drawings can be obtained from those skilled in the art according to these drawings without any creative work.

FIG. 1 is a flowchart of a method for routing signal line according to one or more embodiments of the present disclosure.

FIG. 2 is another flowchart of a method for routing signal line according to one or more embodiments of the present disclosure.

FIG. 3 is another flowchart of a method for routing signal line according to one or more embodiments of the present disclosure.

FIG. 4 is an impedance simulation diagram of a signal line crossing an original segmentation region according to one or more embodiments of the present disclosure.

FIG. 5 is a schematic cross-sectional view of PCB signal line routing and stacking according to one or more embodiments of the present disclosure.

FIG. 6 is a schematic diagram of a signal via according to one or more embodiments of the present disclosure.

FIG. 7 is an impedance simulation diagram of a thickened signal line according to one or more embodiments of the present disclosure.

FIG. 8 is a signal impedance comparison diagram of different routing modes according to one or more embodiments of the present disclosure.

FIG. 9 is an insertion loss result comparison diagram of different routing modes according to one or more embodiments of the present disclosure.

FIG. 10 is a return loss result comparison diagram of different routing modes according to one or more embodiments of the present disclosure.

FIG. 11 is a structural block diagram of an apparatus for routing signal line according to one or more embodiments of the present disclosure.

FIG. 12 is a schematic diagram of a hardware structure of an electronic device according to one or more embodiments of the present disclosure.

### DETAILED DESCRIPTION OF THE EMBODIMENTS

In order to make objectives, technical solutions, and advantages of embodiments of the present disclosure clearer, the technical solutions in the embodiments of the present disclosure will be clearly and completely described below in combination with the drawings in the embodiments of the present disclosure. It is apparent that the described embodiments are part of the embodiments of the present disclosure, not all the embodiments. Based on the embodiments in the application, all other embodiments obtained by those skilled in the art without creative work shall fall within the protection scope of this application.

During actual Printed Circuit Board (PCB) routing, an incomplete reference plane is caused due to the segmentation of a power plane or the segmentation of a ground plane, resulting in a problem of segmentation crossing arrangement of a signal line. For the problem, the number of PCB layers may be increased to make each pair of high-speed signals have complete reference planes. However, the cost of PCBs is undoubtedly increased due to the increase in the number of PCB layers. Alternatively, the high-speed signal is enabled to pass through networks of two planes segmented by the reference plane by means of increasing stitching capacitors, but due to structural limitations, there may be no space to place stitching capacitors. The problem of segmentation crossing arrangement of the signal line in the case of limited space and limited number of PCB layers has not been effectively resolved yet.

Based on this, by means of the technical solutions of the embodiments of the present disclosure, by optimizing the segmentation region corresponding to the reference plane of the PCB to enable the segmentation region to completely cover the signal line, impedance mutation caused by segmentation crossing arrangement of the signal line is avoided, the signal characteristics of the signal line are optimized, and the link integrity of the signal line is ensured.

An embodiment of the present disclosure provides an embodiment of a method for routing signal line. It is to be noted that the steps shown in the flowchart of the accompanying drawings may be executed in a computer system, such as a set of computer-executable instructions, and although a logical sequence is shown in the flowchart, in some cases, the steps shown or described may be executed in a different order than here.

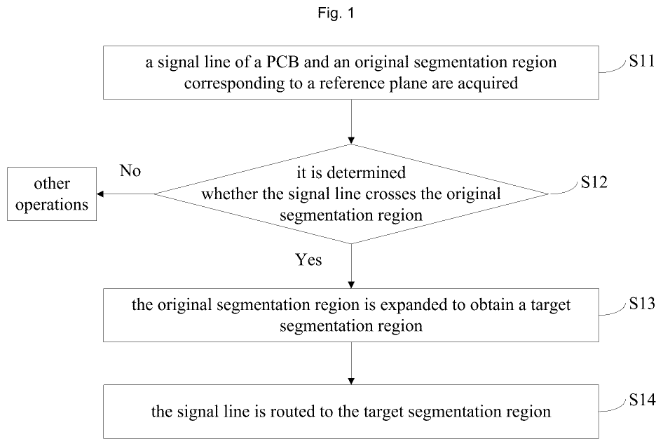

This embodiment provides a method for routing signal line. The method is applicable to an electronic device, such as a mobile phone, a table computer, a computer, etc. FIG. 1 is a flowchart of a method for routing signal line according to an embodiment of the present disclosure. As shown in FIG. 1, the flow includes the following steps.

At S11, a signal line of a PCB and an original segmentation region corresponding to a reference plane are acquired.

The signal line is a transmission line of a high-speed signal on the PCB. The transmission line is generally an impedance line, such as a microstrip differential line. The reference plane is a plane where a reference path of the high-speed signal is located, and the reference path is a return path corresponding to the high-speed signal. The original segmentation region is a space region between the reference planes with different network attributes when a reference plane is incomplete. Specifically, the electronic device may identify an incomplete reference plane in the PCB to determine the original segmentation region, and identify signal lines arranged in the PCB at the same time.

At S12, it is determined whether the signal line crosses the original segmentation region.

Whether an arrangement position of the signal line crosses the original segmentation region is determined. In response to the signal line crossing the original segmentation region, the original segmentation region is expanded to obtain a target segmentation region. In response to the signal line not crossing the original segmentation region, set positions of other signal lines are identified; or in response to the signal line not crossing the original segmentation region, analog simulation is performed on the signal line to determine impedance of the signal line.

The arrangement position of the signal line is identified to determine whether the arrangement position crosses the original segmentation region. When the signal line crosses the original segmentation region, S13 is executed, otherwise other operations are executed. Other operations may be to identify arrangement positions of other signal lines, and may also be to perform the analog simulation on the current signal line to determine the impedance of the current signal line, such that the problem of improperly-connected signal lines is avoided, and other operations are not specifically limited herein.

Specifically, the electronic device may establish a coordinate system corresponding to the PCB, so as to determine a coordinate range corresponding to the arrangement position of the signal line and a coordinate range of the original segmentation region. The two coordinate ranges are compared to determine whether the coordinate range corresponding to the arrangement position of the signal line exceeds the coordinate range of the original segmentation region. If the coordinate range corresponding to the arrangement position of the signal line exceeds the coordinate range of the original segmentation region, it indicates that the signal line crosses the original segmentation region.

At S13, the original segmentation region is expanded to obtain a target segmentation region.

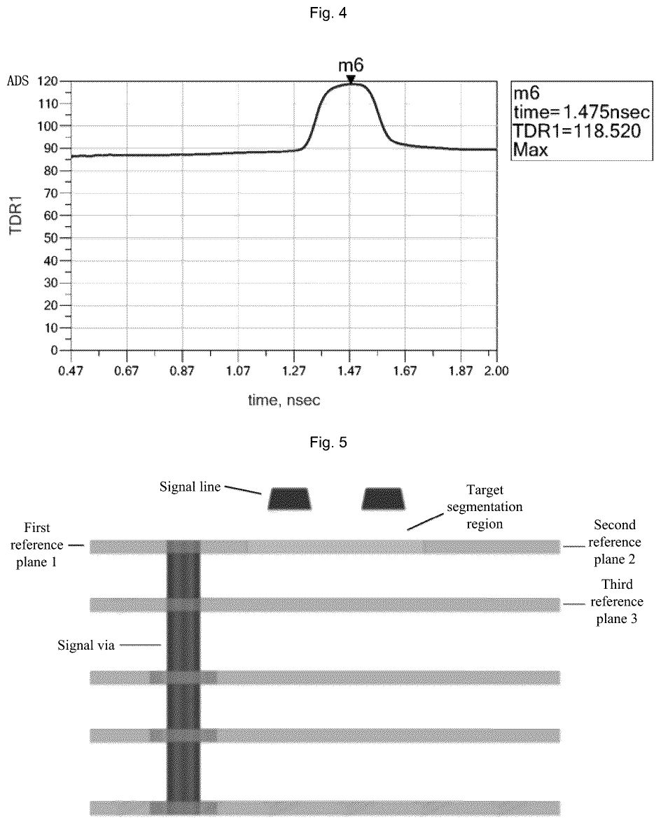

The target segmentation region is an adjusted segmentation region. When the signal line crosses the original segmentation region, impedance mutation occurs in the signal line. As shown in FIG. 4, serious impedance mutation occurs in the signal line crossing the segmentation region, which has exceeded a range of 85Ω±10%, resulting in adverse effects such as reflections in signals.

In order to guarantee the impedance continuity of the signal line, the corresponding reference plane should be complete. When the signal line crosses the original segmentation region, it indicates that the reference plane corresponding to the signal line is incomplete, and in this case, even if the reference plane is expanded, it is difficult to expand the reference plane to a point where the signal line can be fully referenced. In order to avoid impedance mutation, the target segmentation region may be obtained by reducing the reference plane and expanding the original segmentation region, so as to enable the signal line to be completely disposed in the target segmentation region.

At S14, the signal line is routed to the target segmentation region.

When the target segmentation region covering the signal line is obtained, the signal line may be completely routed to the target segmentation region, such that the reference plane corresponding to the signal line is guaranteed to be complete, so as to avoid impedance mutation of the signal line.

According to the method for routing signal line provided in this embodiment, the signal line of the PCB and the original segmentation region corresponding to the reference plane are acquired, and when it is detected that the signal line crosses the original segmentation region, the original segmentation region is expanded to enable the signal line to be completely routed to the target segmentation region. In this way, without the need to increase the number of PCB layers and the number of stitching capacitors, the signal line is placed in the target segmentation region in the case of limited space and limited number of PCB layers, such that the signal integrity is prevented from being affected by impedance mutation due to segmentation crossing arrangement of the signal line, the signal characteristics of signal line routing are optimized, and the link integrity of the signal line is ensured.

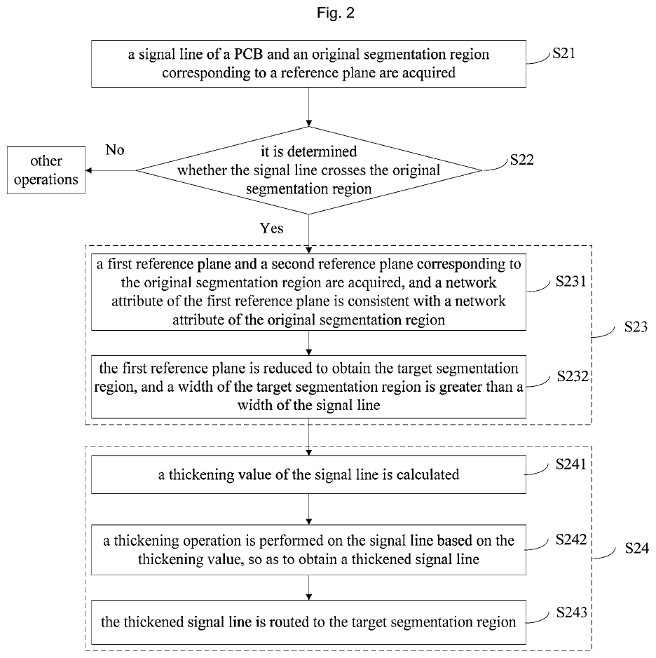

This embodiment provides a method for routing signal line. The method is applicable to an electronic device, such as a mobile phone, a table computer, a computer, etc. FIG. 2 is a flowchart of a method for routing signal line according to an embodiment of the present disclosure. As shown in FIG. 2, the flow includes the following steps.

At S21, a signal line of a PCB and an original segmentation region corresponding to a reference plane are acquired. Details refer to related descriptions of S11 corresponding to the above embodiments, and are not described herein again.

At S22, it is determined whether the signal line crosses the original segmentation region. Details refer to related descriptions of S12 corresponding to the above embodiments, and are not described herein again.

At S23, in response to the signal line crosses the original segmentation region, the original segmentation region is expanded to obtain a target segmentation region.

Specifically, S23 may include the following steps.

At S231, a first reference plane and a second reference plane corresponding to the original segmentation region are acquired, and a network attribute of the first reference plane is consistent with a network attribute of the original segmentation region.

The signal line is located at a surface layer of the PCB, and the reference plane of the signal line should be the complete first reference plane 1. However, due to the segmentation of a plane of an L02 layer, the second reference plane 2 is segmented, such that the first reference plane 1 and the second reference plane 2 both are located at the next layer L02 layer of the surface layer. The first reference plane 1 and the second reference plane 2 have different network attributes, and the first reference plane 1 and the original segmentation region have the same network attribute. For example, the network attribute of the first reference plane 1 is an earth attribute, and the network attribute of the second reference plane 2 is a power attribute. The original segmentation region is located between the first reference plane 1 and the second reference plane 2, and has the same network attribute as the first reference plane 1, as shown in FIG. 5.

At S232, the first reference plane is reduced to obtain the target segmentation region, and a width of the target segmentation region is greater than a width of the signal line.

The first reference plane is reduced to expand the original segmentation region between the first reference plane and the second reference plane, to obtain the target segmentation region, so as to make the width of the target segmentation region greater than the width of the signal line, such that the signal line can completely fall into the target segmentation region. It is to be noted that, in order to prevent the reduction of the reference plane from affecting signal transmission of the signal line, signal compensation may be performed by thickening the signal line, such that the target segmentation region may be left with a certain margin on the basis of completely covering the signal line, so as to ensure that the target segmentation region can cover the thickened signal line.

At S24, the signal line is routed to the target segmentation region.

Specifically, S24 may include the following steps.

At S241, a thickening value of the signal line is calculated.

The thickening value may be determined according to impedance continuity. When it is determined that the signal line is disposed in the target segmentation region, the signal line may also be thickened according to a simulation result of the signal line, so as to prevent the first reference plane from being reduced to affect the impedance continuity of the signal line. Specifically, if a line width of the signal line is 5 mil, and a spacing is 7 mil, modeling and simulation are performed on the signal line through ADS software. A specific thickening value may be calculated by the ADS software. For example, the line width of the signal line is thickened to 13 mil, and the spacing is 6 mil.

At S242, a thickening operation is performed on the signal line based on the thickening value, so as to obtain a thickened signal line.

The thickening operation is performed on the signal line based on the thickening value calculated by the ADS software, then the signal line may be automatically thickened based on the thickening operation, so as to obtain the thickened signal line, and the thickened signal line subjected to the thickening operation is simulated, such as simulation of widening the line width of the signal line shown in FIG. 7 to 13 mil and enlarging the spacing to 6 mil, such that impedance continuity in the thickened signal line processed by the thickening operation is obviously optimized.

At S243, the thickened signal line is routed to the target segmentation region.

After the electronic device obtains the thickened signal line, the thickened signal line may be completed routed to the target segmentation region, and in this case, the reference plane corresponding to the thickened signal line is complete. Therefore, the impedance continuity is further optimized on the basis of avoiding impedance mutation of the signal line.

According to the method for routing signal line provided in this embodiment, since the first reference plane and the original segmentation region have the same network attribute, the original segmentation region is expanded by reducing the first reference plane, such that the signal line can be ensured to completely fall in the segmentation region between the first reference plane and the second reference plane. Signal compensation is performed on the signal characteristics by thickening the signal line to reduce impedance mutation, such that segmentation crossing arrangement of the signal line is prevented from affecting the signal characteristics, and signal impedance continuity is guaranteed.

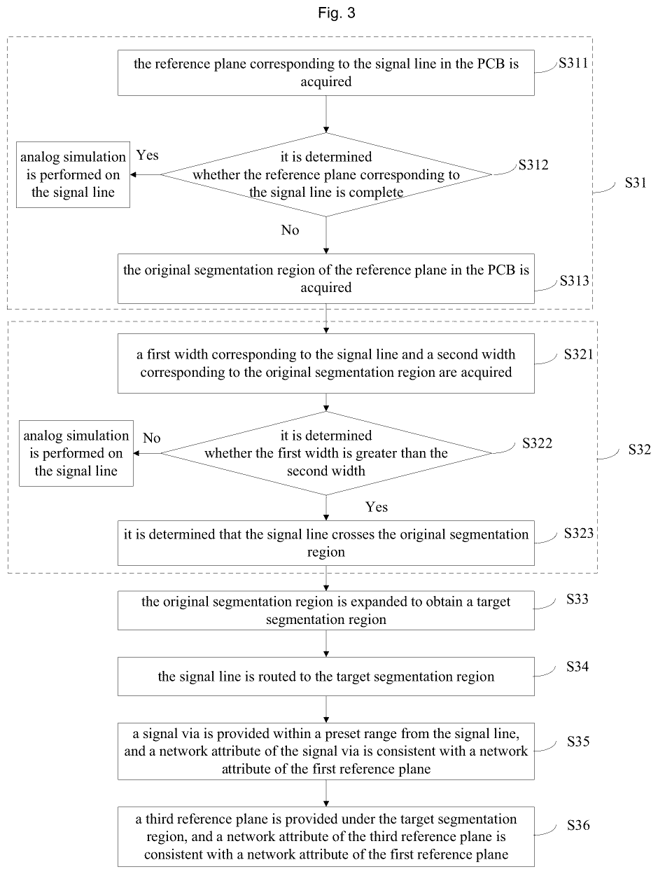

This embodiment provides a method for routing signal line. The method is applicable to an electronic device, such as a mobile phone, a table computer, a computer, etc. FIG. 3 is a flowchart of a method for routing signal line according to an embodiment of the present disclosure. As shown in FIG. 3, the flow includes the following steps.

At S31, a signal line of a PCB and an original segmentation region corresponding to a reference plane are acquired.

Specifically, S31 may include the following steps.

At S311, the reference plane corresponding to the signal line in the PCB is acquired.

After the electronic device determines the signal line of the PCB, routing information such as a routing direction and routing shape of the signal line may be identified, and then the reference plane corresponding to the signal line of the PCB is determined based on the routing information such as the routing direction and routing shape of the signal line.

At S312, it is determined whether the reference plane corresponding to the signal line is complete.

Whether the reference plane corresponding to the signal line is complete is determined; in response to the reference plane corresponding to the signal line being incomplete, the original segmentation region of the reference plane in the PCB is acquired; and in response to the reference plane corresponding to the signal line being complete, analog simulation is performed on the signal line to determine signal characteristics of the signal line.

After determining the reference plane where the signal line is located, the electronic device further identifies the integrity of the reference plane, and determines whether the reference plane corresponding to the signal line is complete. When the reference plane corresponding to the signal line is incomplete, S313 is executed, otherwise it indicates that the reference plane corresponding to the signal line is complete, analog simulation is performed on the signal line to determine signal characteristics of the current signal line.

At S313, the original segmentation region of the reference plane in the PCB is acquired.

When the reference plane corresponding to the signal line is incomplete, it indicates that the signal line may cross the original segmentation region, in this case, in order to further determine whether the signal line crosses the original segmentation region, the electronic device may acquire the original segmentation region of the reference plane corresponding to the signal line. Details refer to related descriptions corresponding to the above embodiments, and are not described herein again.

At S32, it is determined whether the signal line crosses the original segmentation region.

Specifically, S32 may include the following steps.

At S321, a first width corresponding to the signal line and a second width corresponding to the original segmentation region are acquired.

The first width of the signal line is a line width corresponding to the signal line on the PCB, and the second width is a width corresponding to the original segmentation region, i.e., a distance between the first reference plane and the second reference plane. Specifically, the first width of the signal line may be determined based on a design requirement of the signal line, and the second width may be determined by calculating the distance between the first reference plane and the second reference plane.

At S322, it is determined whether the first width is greater than the second width.

Whether the first width is greater than the second width is determined; in response to the first width being greater than the second width, it is determined that the signal line crosses the original segmentation region; and in response to the first width being less than or equal to the second width, it is determined that the signal line does not cross the original segmentation region.

A size relationship between the first width and the second width is compared to determine whether the first width is greater than the second width. When the first width is greater than the second width, S323 is executed, otherwise it indicates that the signal line does not cross the original segmentation region.

At S323, it is determined that the signal line crosses the original segmentation region.

When the first width is greater than the second width, it indicates that the original segmentation region cannot cover the signal line, i.e., the signal line cannot be completely disposed in the original segmentation region, and in this case, it may be determined that the signal line with the first width crosses the original segmentation region in the PCB.

At S33, when the signal line crosses the original segmentation region, the original segmentation region is expanded to obtain a target segmentation region. Details refer to related descriptions of S13 corresponding to the above embodiments, and are not described herein again.

At S34, the signal line is routed to the target segmentation region. Details refer to related descriptions of S14 corresponding to the above embodiments, and are not described herein again.

At S35, a signal via is provided within a preset range from the signal line, and a network attribute of the signal via is consistent with a network attribute of the first reference plane.

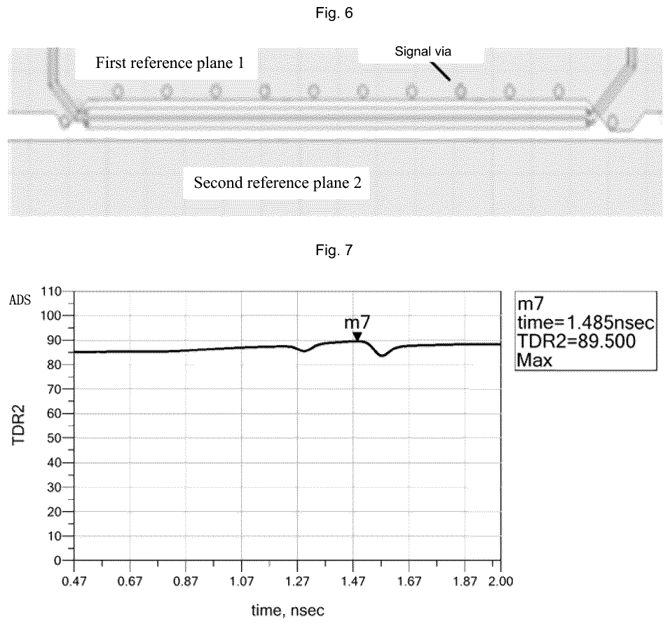

The preset range is a range of a distance between the signal line and the signal via. The signal via is a signal reflow via corresponding to the signal line. The network attribute of the signal via is consistent with the network attribute of the first reference plane. Specifically, the signal via is provided in the first reference plane, and provided within a range 10-40 mil from the signal line, as shown in FIG. 6. Therefore, the signal via is provided within the preset range from the signal line, and the network attribute of the signal via is consistent with the network attribute of the first reference plane, such that signal reflow of the signal line is achieved by providing the signal via, so as to reduce signal return loss.

At S36, a third reference plane is provided under the target segmentation region, and a network attribute of the third reference plane is consistent with a network attribute of the first reference plane.

The third reference plane is provided under the target segmentation region to perform compensation on the signal, such that signal impairment is avoided. As shown in FIG. 5, the third reference plane 3 is provided under the target segmentation region, i.e., the third reference plane is located at an L03 layer, and has the same network attribute as the first reference plane 1. For example, the network attributes of the third reference plane and the first reference plane both are earth attributes, such that compensation of the signal characteristics is realized by optimizing PCB stacking.

According to the method for routing signal line provided in this embodiment of the present disclosure, the original segmentation region is identified when the reference plane corresponding to the signal line is incomplete, such that there is no need to perform segmentation region identification on a complete reference plane, and identification efficiency of the segmentation region is improved, thereby improving routing efficiency of the signal line. By acquiring the first width corresponding to the signal line and the second width corresponding to the original segmentation region, and determining whether the signal line crosses the original segmentation region based on the size relationship between the first width and the second width, whether the signal line crosses the original segmentation region can be accurately determined, such that the width of the segmentation region can be timely adjusted when it is determined that the signal line crosses the segmentation region. Signal return loss is reduced by providing the signal via on the first reference plane to achieve signal reflow of the signal line. By increasing the third reference plane, PCB stacking is optimized, such that signal compensation is performed on the signal characteristics, and the original segmentation region is prevented from being expanded to affect the signal characteristics.

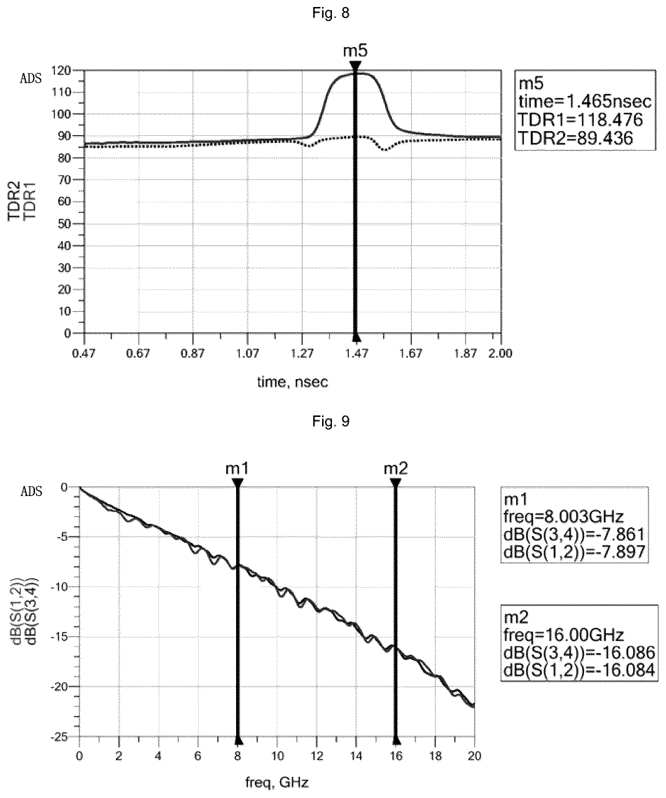

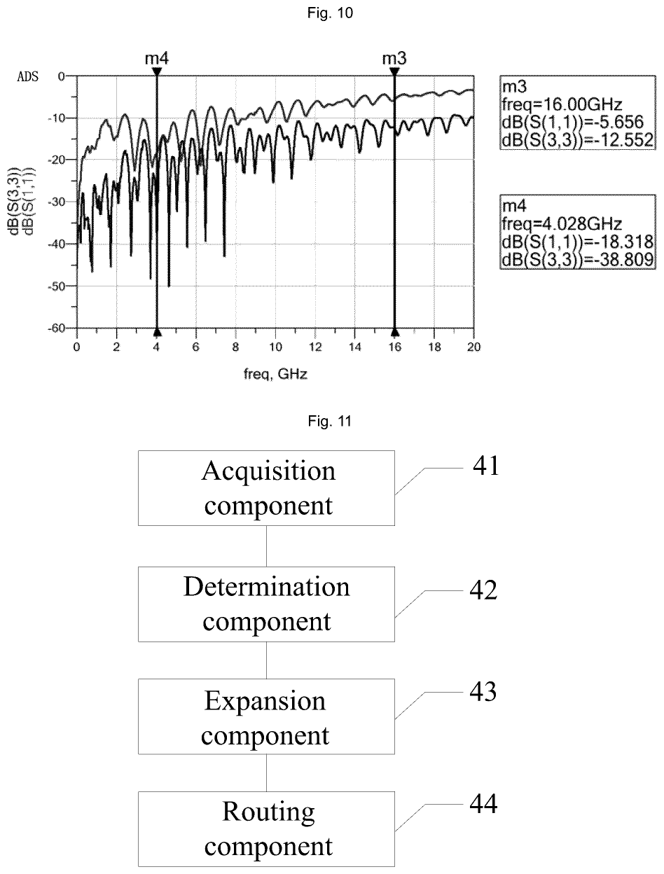

A routing mode using the signal line and impedance characteristics of the signal line crossing the original segmentation region are compared in the same graph. As shown in FIG. 8, a solid line represents an impedance result of the signal line crossing the original segmentation region, and a dotted line represents an impedance result of the routing mode using the signal line. From comparison of simulation results, it may be seen that, the impedance can meet a range of 85Ω±10% at the segmentation region. Analog simulation is performed on the routing mode using the signal line and a loss result of the signal line crossing the original segmentation region, such as insertion loss result comparison shown in FIG. 9 and return loss result comparison shown in FIG. 10. Based on the simulation results, it may be learned that compared with the signal line crossing the original segmentation region, signal line routing by the routing mode using the signal line is not obvious in insertion loss result, but good in return loss result. Therefore, according to the method for routing signal line, on the basis of solving impedance mutation caused by segmentation region crossing, the signal characteristics of the signal line are optimized, and the integrity of an entire link signal is improved.

This embodiment further provides an apparatus for routing signal line. The apparatus is configured to implement the foregoing embodiments and the preferred implementation, and what has been described will not be described again. As used below, the term “component” may be a combination of software and/or hardware that implements a predetermined function. Although the apparatus described in the following embodiments is preferably implemented in software, but implementations in hardware, or a combination of software and hardware, are also possible and conceived.

This embodiment provides an apparatus for routing signal line. As shown in FIG. 11, the apparatus includes an acquisition component, a determination component, an expansion component, and a routing component.

The acquisition component 41 is configured to acquire a signal line of a PCB and an original segmentation region corresponding to a reference plane. Details refer to related descriptions corresponding to the above method embodiments, and are not described herein again.

The determination component 42 is configured to determine whether the signal line crosses the original segmentation region. Details refer to related descriptions corresponding to the above method embodiments, and are not described herein again.

The expansion component 43 is configured to in response to the signal line crossing the original segmentation region, expand the original segmentation region to obtain a target segmentation region. Details refer to related descriptions corresponding to the above method embodiments, and are not described herein again.

The routing component 44 is configured to route the signal line to the target segmentation region. Details refer to related descriptions corresponding to the above method embodiments, and are not described herein again.

According to the apparatus for routing signal line provided in this embodiment, the signal line of the PCB and the original segmentation region corresponding to the reference plane are acquired, and when it is detected that the signal line crosses the original segmentation region, the original segmentation region is expanded to enable the signal line to be completely routed to the target segmentation region. In this way, without the need to increase the number of PCB layers and the number of stitching capacitors, the signal line is placed in the target segmentation region in the case of limited space and limited number of PCB layers, such that the signal integrity is prevented from being affected by impedance mutation due to segmentation crossing arrangement of the signal line, the signal characteristics of signal line routing are optimized, and the link integrity of the signal line is ensured.

The apparatus for routing signal line in this embodiment is presented in the form of a functional unit. The unit here refers to an Application Specific Integrated Circuit (ASIC), a processor and a memory executing one or more software or fixed programs, and/or other devices that may provide the above functions.

Further function descriptions of the components are the same as the corresponding embodiments, and are not described herein again.

An embodiment of the present disclosure further provides an electronic device, which is provided with an apparatus for routing signal line shown in FIG. 11.

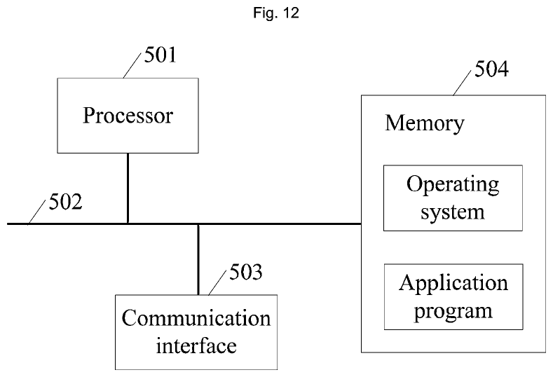

Referring to FIG. 12, FIG. 12 is a schematic structural diagram of an electronic device according to an optional embodiment of the present disclosure. As shown in FIG. 12, the electronic device may include: one or more processors 501 such as a Central Processing Unit (CPU), at least one communication interface 503, a memory 504, and at least one communication bus 502. The at least one communication bus 502 is configured to achieve connection communication between these assemblies. The at least one communication interface 503 may include a display and a keyboard. Optionally, the at least one communication interface 503 may include a standard wired interface and wireless interface. The memory 504 may be a high-speed Random Access Memory (RAM, which is a volatile RAM), or may be a non-volatile memory, such as at least one disk memory. The memory 504 may optionally be at least one storage apparatus located remotely from the foregoing one or more processor 501. The one or more processor 501 may be combined with the apparatus shown in FIG. 11. The memory 504 stores an application program. The processor 501 calls a program code stored in the memory 504, so as to execute any one of the above method steps.

The communication bus 502 may be a Peripheral Component Interconnect (PCI) bus or an Extended Industry Standard Architecture (EISA) bus, or the like. The communication bus 502 may be divided into an address bus, a data bus, a control bus, and the like. For ease of presentation, only one thick line is used in FIG. 12, but it does not mean that there is only one bus or one type of buses.

The memory 504 may include a volatile memory, such as a Random Access Memory (RAM), or may also include a non-volatile memory, such as a flash memory, a Hard Disk Drive (HDD) or a Solid-State Drive (SSD). The memory 504 may further include a combination of the above types of memories.

The one or more processor 501 may be a CPU, a Network Processor (NP) or a combination of the CPU and the NP.

The one or more processor 501 may further include a hardware chip. The hardware chip may be an Application-Specific Integrated Circuit (ASIC), a Programmable Logic Device (PLD), or a combination thereof. The PLD may be a Complex Programmable Logic Device (CPLD), a Field-Programmable Gate Array (FPGA), a Generic Array Logic (GAL), or any combination thereof.

Optionally, the memory 504 is further configured to store a program instruction. The processor 501 may call the program instruction, so as to implement the method for routing signal line in the embodiments shown in FIGS. 1 to 3.

An embodiment of the present disclosure further provides one or more non-volatile computer-readable storage medium, storing a computer-readable instruction. The computer storage medium stores a computer-executable instruction, and when the computer-readable instruction is executed by one or more processors, the method for routing signal line in any of the above method embodiments may be executed. The storage medium may be a magnetic disk, an optical disk, an ROM, an RAM, a flash memory, an HDD, an SSD, or the like. The storage medium may further include a combination of memories of the above types.

Although the embodiments of the present disclosure are described with reference to the accompanying drawings, those skilled in the art can make various modifications and variations to the present disclosure without departing from the spirit and scope of the present disclosure. Thus, such modifications and variations of the present disclosure fall within the scope of the appended claims.

1. A method for routing signal line, comprising:
acquiring a signal line of a Printed Circuit Board (PCB) and an original segmentation region corresponding to a reference plane;
determining whether the signal line crosses the original segmentation region;
in response to the signal line crossing the original segmentation region, expanding the original segmentation region to obtain a target segmentation region; and
routing the signal line to the target segmentation region.

2. The method as claimed in claim 1, wherein the method further comprises:
in response to the signal line not crossing the original segmentation region, identifying set positions of other signal lines of the PCB; or
in response to the signal line not crossing the original segmentation region, performing analog simulation on the signal line to determine impedance of the signal line.

3. The method as claimed in claim 1, wherein expanding the original segmentation region to obtain the target segmentation region comprises:
acquiring a first reference plane and a second reference plane corresponding to the original segmentation region, wherein a network attribute of the first reference plane is consistent with a network attribute of the original segmentation region; and
reducing the first reference plane to obtain the target segmentation region, wherein a width of the target segmentation region is greater than a width of the signal line.

4. The method as claimed in claim 1, wherein routing the signal line to the target segmentation region comprises:
calculating a thickening value of the signal line;
performing a thickening operation on the signal line based on the thickening value, so as to obtain a thickened signal line; and
routing the thickened signal line to the target segmentation region.

5. The method as claimed in claim 3, wherein the method further comprises:
providing a signal via within a preset range from the signal line, wherein a network attribute of the signal via is consistent with the network attribute of the first reference plane.

6. The method as claimed in claim 3, wherein the method further comprises:
providing a third reference plane under the target segmentation region, wherein a network attribute of the third reference plane is consistent with the network attribute of the first reference plane.

7. The method as claimed in claim 1, wherein acquiring the original segmentation region of the reference plane in the PCB comprises:
acquiring the reference plane corresponding to the signal line in the PCB;
determining whether the reference plane corresponding to the signal line is complete; and
in response to the reference plane corresponding to the signal line being incomplete, acquiring the original segmentation region of the reference plane in the PCB.

8. The method as claimed in claim 7, wherein the method further comprises:
in response to the reference plane corresponding to the signal line being complete, performing analog simulation on the signal line to determine signal characteristics of the signal line.

9. The method as claimed in claim 1, wherein determining whether the signal line crosses the original segmentation region comprises:
acquiring a first width corresponding to the signal line and a second width corresponding to the original segmentation region;
determining whether the first width is greater than the second width; and
in response to the first width being greater than the second width, determining that the signal line crosses the original segmentation region.

10. The method as claimed in claim 9, wherein the method further comprises:
in response to the first width being less than or equal to the second width, determining that the signal line does not cross the original segmentation region.

11. (canceled)

12. An electronic device, comprising a memory, and one or more processors, wherein the memory stores a computer-readable instruction, and when the computer-readable instruction is executed by the one or more processors, the computer-readable instruction cause the one or more processors to:
acquire a signal line of a Printed Circuit Board (PCB) and an original segmentation region corresponding to a reference plane;
determine whether the signal line crosses the original segmentation region;
in response to the signal line crossing the original segmentation region, expand the original segmentation region to obtain a target segmentation region; and
route the signal line to the target segmentation region.

13. One or more non-volatile computer-readable storage medium, storing a computer-readable instruction, wherein when the computer-readable instruction is executed by one or more processors, the computer-readable instruction is configured to cause the one or more processors to:
acquire a signal line of a Printed Circuit Board (PCB) and an original segmentation region corresponding to a reference plane;
determine whether the signal line crosses the original segmentation region;
in response to the signal line crossing the original segmentation region, expand the original segmentation region to obtain a target segmentation region; and
route the signal line to the target segmentation region.

14. The method as claimed in claim 1, wherein determining whether the signal line crosses the original segmentation region comprises:
establishing a coordinate system corresponding to the PCB, so as to determine a coordinate range corresponding to an arrangement position of the signal line and a coordinate range of the original segmentation region;
comparing the coordinate range corresponding to the arrangement position of the signal line and the coordinate range of the original segmentation region to determine whether the coordinate range corresponding to the arrangement position of the signal line exceeds the coordinate range of the original segmentation region;
in response to the coordinate range corresponding to the arrangement position of the signal line exceeding the coordinate range of the original segmentation region, determining that the signal line crosses the original segmentation region.

15. The method as claimed in claim 4, wherein calculating the thickening value of the signal line comprises:
determining the thickening value according to impedance continuity.

16. The method as claimed in claim 7, wherein acquiring the reference plane corresponding to the signal line in the PCB comprises:
after determining the signal line of the PCB, identifying routing information;
determining the reference plane corresponding to the signal line of the PCB based on the routing information.

17. The method as claimed in claim 16, wherein the routing information comprises a routing direction and routing shape of the signal line.

18. The method as claimed in claim 5, wherein the signal via is provided in the first reference plane, and provided within a range 10-40 mil from the signal line.

19. The method as claimed in claim 1, wherein the original segmentation region is a space region between the reference planes with different network attributes when a reference plane is incomplete.

20. The method as claimed in claim 1, wherein determining whether the signal line crosses the original segmentation region comprises:
identifying an arrangement position of the signal line to determine whether the arrangement position crosses the original segmentation region.

21. The method as claimed in claim 1, wherein expanding the original segmentation region to obtain a target segmentation region comprises:
obtaining the target segmentation region by reducing the reference plane and expanding the original segmentation region.
